(19) United States
(12) Patent Application Publication
(10) Pub. No.: US 2012/0194074 A1
(43) Pub. Date: Aug. 2, 2012

(54) PLASMA CHOKING METHOD AND PLASMA CHOKE COIL

(75) Inventor: PING-LI LAI, TAICHUNG CITY (TW)

(73) Assignees: JIAHE INVESTMENT CO., LTD., TAIPEI CITY (TW); PING-LI LAI, TAICHUNG CITY (TW)

(21) Appl. No.: 13/351,515

(22) Filed: Jan. 17, 2012

(30) Foreign Application Priority Data
Jan. 28, 2011 (TW) 100103298

(51) Int. Cl. H05H 1/24

(52) U.S. Cl. 315/111.21

(57) ABSTRACT

A plasma choking method and a plasma choke coil. The plasma choking method includes steps of installing at least one conductive coil set in a closed space and filling a reaction fluid into the closed space. When a circuit is interfered with by external surge or the surge in the circuit, the surge applies an electric field or a magnetic field to the conductive coil. At this time, the conductive coil in the closed space generates an inductive reactance corresponding to the surge and carries out plasma reaction, whereby the surface particles of the conductive coil are ionized by the magnetic field or electric field into high-energy electrons, high-energy ions and high-energy neutral atoms so as to effectively eliminate or absorb the surge.

### BACKGROUND OF THE INVENTION

1. Field of the Invention

The present invention relates generally to a plasma choking method and a plasma choke coil. By means of the plasma choking method and plasma choke coil, the external surge or the surge in the circuit are conducted into the plasma choke coil to carry out plasma reaction. The surface particles of the conductive coil of the plasma choke coil are ionized by magnetic field or electric field into high-energy electrons, high-energy ions and high-energy neutral atoms so as to effectively eliminate or absorb the surge.

2. Description of the Prior Art

Various choke coils are applied to various electrical products with different functions to increase energy utilization ratio, reduce power loss and prolong lifetime of the electrical products. A common choke coil is formed of an inductor composed of a coil and silicon steel sheets around which the coil is wound.

It is known that the semiconductor device of an integrated circuit (IC) or large-scale integrated circuit (LSI) is often damaged or deteriorated in performance due to high voltage static electricity. For solving the problem caused by static electricity, a surge absorption element is used in the semiconductor device. The surge absorption element is formed of an inductor or composed of an inductor (so-called “choke coil” when used to absorb the surge) and a varistor.

It is well known that a solenoid is formed of a uniformly spiraled elongated conductive wire. According to Ampere's Circuit Law, when the solenoid is powered on, a uniform magnetic field is created in the solenoid. A solenoid with a soft iron core (magnetic iron material) positioned therein has a magnetic flux much greater than the magnetic flux of a hollow solenoid. However, an eddy current will be produced in the soft iron core to generate heat and cause loss of magnetic energy or interference.

To solve the above problems, the soft iron core can be replaced with thinner multilayer laminated silicon steel sheets to lower the saturation of magnetic path and reduce eddy current. Accordingly, the problems of heat and loss of energy due to the eddy current can be properly solved. However, the eddy current still can be hardly thoroughly eliminated so that the problems of heat and the resultant loss of energy still exist. Moreover, the weight and volume of the solenoid will be increased as a whole.

Therefore, in the case that the inductor is used as a surge absorption element, the electrical energy will be inevitably converted into heat to lower the quality factor (abbreviated as Q value) of the inductor.

### SUMMARY OF THE INVENTION

It is therefore a primary object of the present invention to provide a plasma choking method and a plasma choke coil to solve the problem existing in the conventional surge absorption element formed of an inductor that the electrical energy will be inevitably converted into heat to lower the quality factor (Q value) of the inductor.

To achieve the above and other objects, in the plasma choking method of the present invention, at least one conductive coil set is installed in a closed space. A reaction fluid (“fluid” means gas or liquid) is filled in the closed space. The conductive coil can generate an inductive reactance corresponding to the external surge, (that is, an inductive electromotive force corresponding to the external surge). Accordingly, the conductive coil and the reaction fluid in the closed space interact on each other to carry out plasma reaction, (that is, the surface particles of the conductive coil are ionized by magnetic field or electric field into high-energy electrons, high-energy ions and high-energy neutral atoms) to eliminate or absorb the external surge.

In the above plasma choking method, one or multiple conductive coil sets are arranged in the closed space.

In the above plasma choking method, the multiple conductive coil sets are symmetrically arranged.

In the above plasma choking method, the conductive coil set or at least one of the conductive coil sets has at least one terminal extending out of the closed space.

In the above plasma choking method, the conductive coil set or at least one of the conductive coil sets has at least one terminal sealedly enclosed in the closed space without contacting the exterior of the closed space.

Still to achieve the above and other objects, the plasma choke coil of the present invention includes a closed space and at least one conductive coil set installed in the closed space. A reaction fluid (“fluid” means gas or liquid) is filled in the closed space. The conductive coil can generate an inductive reactance corresponding to the external surge, (that is, an inductive electromotive force corresponding to the external surge), whereby the plasma choke coil carries out plasma reaction, (that is, the surface particles of the conductive coil are ionized by magnetic field or electric field into high-energy electrons, high-energy ions and high-energy neutral atoms) to eliminate or absorb the external surge.

The plasma choke coil includes one or multiple conductive coil sets.

In the above plasma choke coil, the multiple conductive coil sets are symmetrically arranged.

In the above plasma choke coil, the conductive coil set or at least one of the conductive coil sets has at least one terminal extending out of the closed space.

In the above plasma choke coil, the conductive coil set or at least one of the conductive coil sets has at least one terminal sealedly enclosed in the closed space without contacting the exterior of the closed space.

By means of the plasma choking method and the plasma choke coil of the present invention, the reaction fluid (“fluid” means gas or liquid) contained in the closed space can be ionized to absorb the surge. The ionized reaction fluid will spirally move along the surface of the conductive coil to create a slight magnetic field to lower the resistance of the signal necessary for the conductive coil so as to minimize interference and increase quality factor (Q value).

The present invention can be best understood through the following description and accompanying drawings, wherein:

### BRIEF DESCRIPTION OF THE DRAWINGS

FIG. 1 is a perspective view of a first embodiment of the present invention;

FIG. 2 is a sectional view taken along line 2-2 of FIG. 1;

FIG. 3 is a sectional view of a second embodiment of the present invention;

FIG. 4 is a sectional view of a third embodiment of the present invention;

FIG. 5 is a sectional view of a fourth embodiment of the present invention;

FIG. 6 is a sectional view of a fifth embodiment of the present invention; and

FIG. 7 is a sectional view of a sixth embodiment of the present invention.

### DETAILED DESCRIPTION OF THE PREFERRED EMBODIMENTS

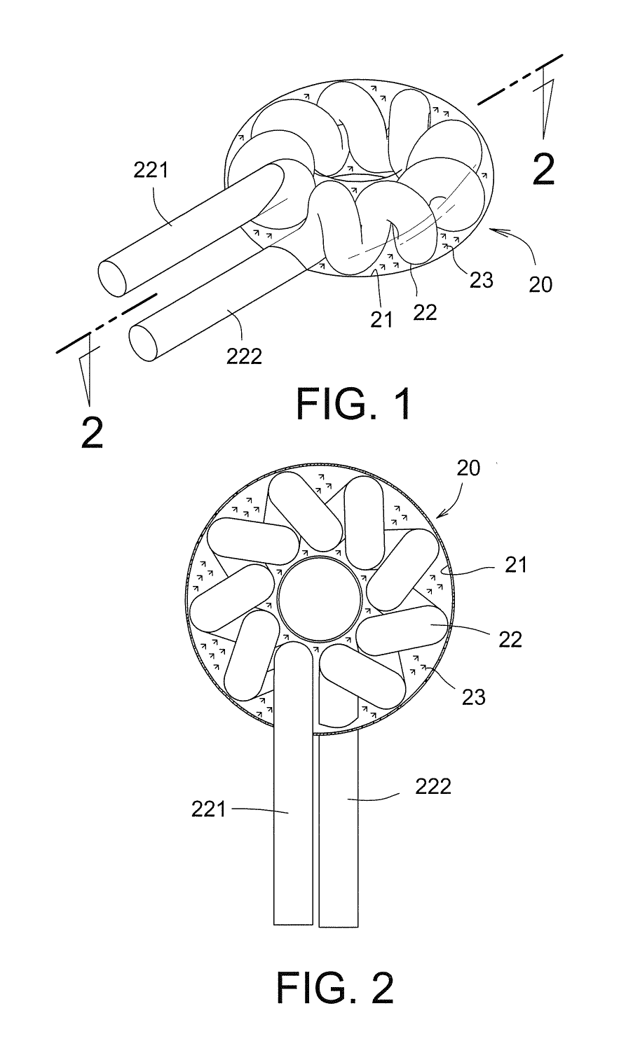

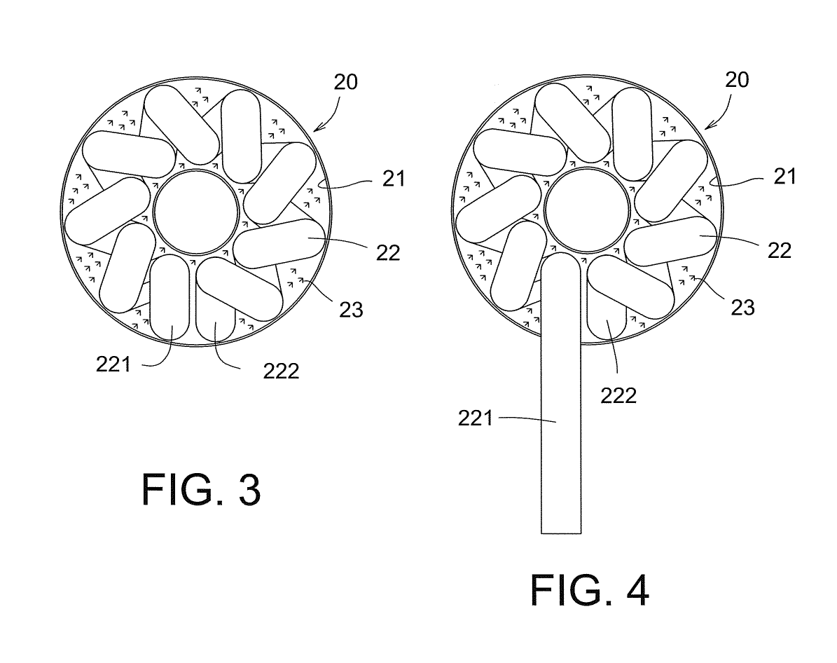

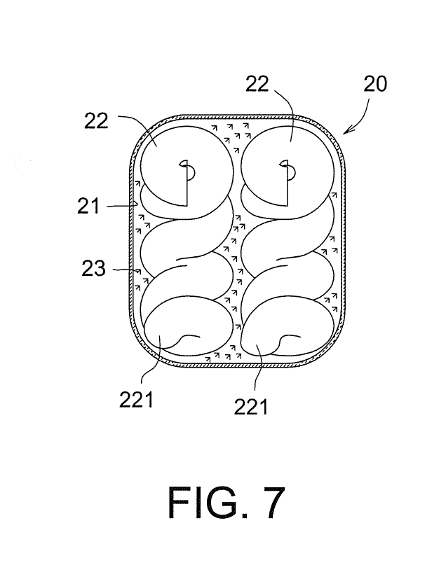

Please refer to FIGS. 1 to 7. The present invention provides a plasma choking method in which at least one conductive coil set 22 is installed in a closed space 21. A reaction fluid 23 (“fluid” means gas or liquid) is filled in the closed space 21 (at a pressure of, for example, 0.5 Torr). By way of non-contact induction or direct-contact conduction, an inductive reactance corresponding to the external surge, (that is, an inductive electromotive force corresponding to the external surge) is generated, whereby the conductive coil 22 and the reaction fluid 23 in the closed space 21 interact on each other to carry out plasma reaction in the closed space 21, (that is, the surface particles of the conductive coil 22 are ionized by magnetic field or electric field into high-energy electrons, high-energy ions and high-energy neutral atoms) to eliminate or absorb the external surge.

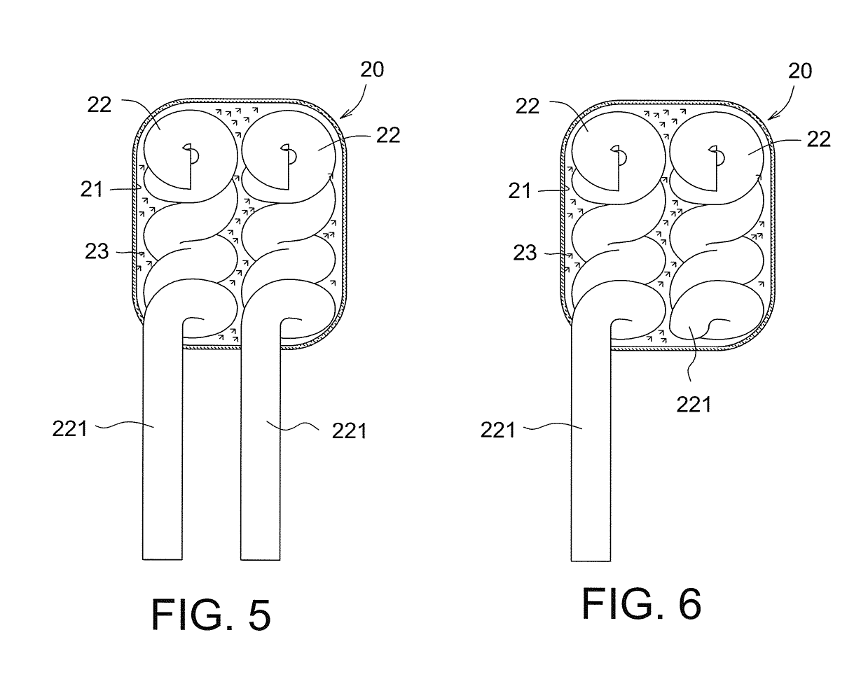

Please refer to FIGS. 1 to 7. In the plasma choking method of the present invention, one conductive coil set 22 (as shown in FIGS. 1 to 4) or multiple conductive coil sets 22 (as shown in FIGS. 5 to 7) are arranged in the closed space 21. In the case of multiplicity, the multiple conductive coil sets 22 are symmetrically arranged. As shown in FIGS. 1 to 4, the conductive coil 22 spirally extends along a circle in the closed space 21.

Please refer to FIGS. 1, 2, 4, 5, 6 and 7. In the plasma choking method of the present invention, the conductive coil set 22 or at least one of the conductive coil sets 22 has at least one terminal 221, 222 extending out of the closed space 21.

In the plasma choking method of the present invention, when the surge takes place, the conductive coil 22 will naturally create impedance against the surge. In the meantime, the conductive coil 22 generates a reverse inductive reactance, (that is, an inductive electromotive force corresponding to the external surge) to ionize the reaction fluid 23 sealedly contained in the closed space 21. In comparison with the conventional design, the small-power surge will be thus absorbed, while the large-power surge will make the reaction fluid 23 more ionized to absorb the surge even by way of glow discharge. The potential of the ionized reaction fluid 23 will come into balance due to the conductive coil 22. During the balance process, the ionized reaction fluid 23 will spirally move along the surface of the conductive coil 22 under the design of the closed space 21. Such move will create a slight magnetic field to lower the resistance of the signal necessary for the conductive coil 22 so as to minimize interference.

Please refer to FIGS. 1 to 7. The present invention also provides a plasma choke coil 20 including a closed space 21 and at least one conductive coil set 22 installed in the closed space 21. A reaction fluid 23 (“fluid” means gas or liquid) is filled in the closed space 21. By way of non-contact induction or direct-contact conduction, an inductive reactance corresponding to the external surge, (that is, an inductive electromotive force corresponding to the external surge) is generated, whereby the plasma choke coil 20 carries out plasma reaction, (that is, the surface particles of the conductive coil 22 are ionized by magnetic field or electric field into high-energy electrons, high-energy ions and high-energy neutral atoms) to eliminate or absorb the external surge.

Please refer to FIGS. 1 to 7. In the plasma choke coil 20 of the present invention, one conductive coil set 22 (as shown in FIGS. 1 to 4) or multiple conductive coil sets 22 (as shown in FIGS. 5 to 7) are arranged in the closed space 21. In the case of multiplicity, the multiple conductive coil sets 22 are symmetrically arranged. As shown in FIGS. 1 to 4, the conductive coil 22 spirally extends along a circle in the closed space 21.

Please refer to FIGS. 1, 2, 4, 5 and 6. In the plasma choke coil 20 of the present invention, the conductive coil set 22 or at least one of the conductive coil sets 22 has at least one terminal 221 (or 222) extending out of the closed space 21.

In the plasma choke coil 20 of the present invention, when the surge takes place, the conductive coil 22 will naturally create impedance against the surge. In the meantime, the conductive coil 22 generates a reverse inductive reactance, (that is, an inductive electromotive force corresponding to the external surge) to ionize the reaction fluid 23 sealedly contained in the closed space 21. In comparison with the conventional design, the small-power surge will be thus absorbed, while the large-power surge will make the reaction fluid 23 more ionized to absorb the surge even by way of glow discharge. The potential of the ionized reaction fluid 23 will come into balance due to the conductive coil 22. During the balance process, the ionized reaction fluid 23 will spirally move along the surface of the conductive coil 22 under the design of the closed space 21. Such move will create a slight magnetic field to lower the resistance of the signal necessary for the conductive coil 22 so as to minimize interference.

The present invention subtly utilizes the characteristic of the fourth phase (plasma phase) of the material to make the ionized reaction fluid 23 move in a manner according to Ampere's Circuit Law. This effect is equivalent to the performance of magnetic iron material. In view of surge, this is a factor of increase of impedance. The inductance of bare copper wire and the conductive coil's own structure can enhance the ionization effect. (The “self-induction” and “ mutual induction” of the conductive coil 22 are both sources of work).

The magnitude of the impedance is adjustable by means of adjusting the pressure of the reaction fluid 23 filled in the closed space 21. (The smaller the power of the radio interference signal to be resisted is, the smaller the pressure of the reaction fluid 23 filled in the closed space 21 is, and vice versa).

In the plasma choke coil 20 of the present invention, the conductive coil 22 only needs to be partially exposed to contact the reaction fluid 23 for plasma reaction. The exposed parts of the conductive coil 22 are not in contact with each other so as to avoid short-circuit. Accordingly, the conductive coil 22 can be, but not limited to, a bare conductive wire (as shown in FIGS. 1 to 7), a stranded wire (not shown) or a conductive plate (with a bare face and an insulation face).

The above embodiments are only used to illustrate the present invention, not intended to limit the scope thereof. Many modifications of the above embodiments can be made without departing from the spirit of the present invention.

What is claimed is:

1. A plasma choking method comprising steps of:
(a) installing at least one conductive coil set in a closed space; and
(b) filling a reaction fluid into the closed space to generate an inductive reactance corresponding to external surge, whereby the conductive coil and the reaction fluid in the closed space interact on each other to carry out plasma reaction so as to eliminate the external surge.

2. The plasma choking method as claimed in claim 1, wherein the conductive coil spirally extends along a circle in the closed space.

3. The plasma choking method as claimed in claim 1, wherein there is only one conductive coil set.

4. The plasma choking method as claimed in claim 1, wherein there are multiple conductive coil sets.

5. The plasma choking method as claimed in claim 4, wherein the multiple conductive coil sets are symmetrically arranged.

6. The plasma choking method as claimed in claim 1, wherein the conductive coil set or at least one of the conductive coil sets has at least one terminal extending out of the closed space.

7. The plasma choking method as claimed in claim 5, wherein the conductive coil set or at least one of the conductive coil sets has at least one terminal extending out of the closed space.

8. The plasma choking method as claimed in claim 1, wherein the conductive coil set or at least one of the conductive coil sets is entirely sealedly enclosed in the closed space without contacting an exterior of the closed space.

9. The plasma choking method as claimed in claim 5, wherein the conductive coil set or at least one of the conductive coil sets is entirely sealedly enclosed in the closed space without contacting an exterior of the closed space.

10. A plasma choke coil comprising:
(a) a closed space; and
(b) at least one conductive coil set installed in the closed space, a reaction fluid being filled in the closed space to generate an inductive reactance corresponding to external surge, whereby the plasma choke coil carries out plasma reaction so as to eliminate the external surge.

11. The plasma choke coil as claimed in claim 10, wherein the conductive coil spirally extends along a circle in the closed space.

12. The plasma choke coil as claimed in claim 10, wherein there is only one conductive coil set.

13. The plasma choke coil as claimed in claim 10, wherein there are multiple conductive coil sets.

14. The plasma choke coil as claimed in claim 13, wherein the multiple conductive coil sets are symmetrically arranged.

15. The plasma choke coil as claimed in claim 10, wherein the conductive coil set or at least one of the conductive coil sets has at least one terminal extending out of the closed space.

16. The plasma choke coil as claimed in claim 14, wherein the conductive coil set or at least one of the conductive coil sets has at least one terminal extending out of the closed space.

17. The plasma choke coil as claimed in claim 10, wherein the conductive coil set or at least one of the conductive coil sets is entirely sealedly enclosed in the closed space without contacting an exterior of the closed space.

18. The plasma choke coil as claimed in claim 14, wherein the conductive coil set or at least one of the conductive coil sets is entirely sealedly enclosed in the closed space without contacting an exterior of the closed space.
